(19) United States
(12) Patent Application Publication
(10) Pub. No.: US 2026/0236771 A1
(43) Pub. Date: Aug. 13, 2026

(54) EXPLAINABLE GRAPH NEURAL NETWORK

(71) Applicant: MFTB Holdco, Inc., Seattle, WA (US)

(72) Inventors: Kunal Mukherjee, Grand Prairie, TX (US); Zachary Harrison, Jackson, WY (US); Saeid Balaneshinkordan, Sammamish, WA (US)

(21) Appl. No.: 19/048,398

(22) Filed: Feb. 7, 2025

(51) Int. Cl. G06N 3/082; G06N 3/042; G06N 3/043

(52) U.S. Cl. CPC G06N 3/082; G06N 3/042; G06N 3/043

(57) ABSTRACT

An explainable graph neural network is disclosed. A recommendation system generates a recommendation by using a trained heterogenous graph neural network. A recommendation explainer may generate an explanation for the recommendation. To do so, the recommendation explainer may perturb features of a node of a heterogenous interaction graph. Further, the recommendation explainer may perturb a structure of the heterogenous interaction graph.

### BACKGROUND

Neural networks process inputs through layers of interconnected components that perform computations on the data. The network adjusts parameters during training to minimize errors between predictions and actual outcomes. As data flows through a neural network, that data is transformed and ultimately used to determine the final output. This process allows the network to learn complex relationships in the data, but how the neural network reaches a final output is often opaque.

In the case of graph neural networks, for example, nodes aggregate information from their neighbors to update their own representations. However, the way in which these networks combine and transform information may be difficult to interpret, leading to results that may be difficult to explain. Explainability is a significant challenge because the interactions between nodes and learned parameters can obscure the rationale behind a network's output, complicating efforts to understand why it made a particular decision.

### SUMMARY

In general terms, this disclosure relates to an explainable graph neural network. In some embodiments, and by non-limiting example, a recommendation system generates a recommendation for a user by using a trained heterogenous graph neural network. A recommendation explainer may generate an explanation for the recommendation. To do so, the recommendation explainer may perturb features of a node of a heterogenous interaction graph. Further, the recommendation explainer may perturb a structure of the heterogenous interaction graph.

In an example aspect, a graph neural network system is disclosed. The system comprises a heterogenous graph neural network trained to perform a link prediction task, the link prediction task comprising determining a likelihood of an edge between a first node of a first node type and a second node of a second node type; a recommendation explainer configured to: perturb features of the second node to identify relevant features of the second node for explaining the likelihood of the edge between the first node and the second node; and using the relevant features of the second node, perturb a structure of the heterogenous graph neural network to identify relevant edges for explaining the likelihood of the edge between the first node and the second node.

In an example aspect, a method for explaining a heterogeneous graph neural network is disclosed. The method comprises receiving a heterogeneous interaction graph comprising a first node of a first node type and a second node of a second node type; receiving data corresponding to a recommendation between the first node and the second node, wherein the recommendation is based on the heterogenous graph neural network processing the interaction graph; perturbing features of the second node to identify relevant features of the second node for explaining the recommendation between the first node and the second node; and perturbing a structure of the heterogenous interaction graph to identify relevant edges for explaining the recommendation between the first node and the second node.

In an example aspect, a recommendation explainer computing system is disclosed. The recommendation explainer computing system comprises a processor; and memory storing instructions that, when executed by the processor, cause the recommendation explainer computing system to: receive data associated with a heterogeneous interaction graph comprising a first node of a first node type and a second node of a second node type; receive a recommendation generated by a heterogenous graph neural network that recommends a region associated with the second node to a user associated with the first node; perturb features of the second node to identify relevant features of the second node for explaining the recommendation; using the relevant features of the second node, perturb a structure of the heterogenous interaction graph to identify relevant edges; and generate the explanation using the relevant features and the relevant edges.

### BRIEF DESCRIPTION OF THE DRAWINGS

FIG. 1 illustrates an example network environment in which aspects of the present disclosure may be implemented.

FIG. 2 is a flowchart of an example method according to aspects of the present disclosure.

FIG. 3 illustrates an example heterogenous interaction graph.

FIG. 4 is a flowchart of an example method of perturbing features.

FIG. 5 is a flowchart of an example method of perturbing a graph structure.

FIG. 6 illustrates aspects of an example operation by a recommendation explainer.

FIG. 7 illustrates an example visualization of an explanation.

FIG. 8 illustrates an example visualization of an explanation.

FIG. 9 illustrates an example application in which aspects of the present disclosure may be implemented.

FIG. 10 illustrates a block diagram of an example computing system.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

In some instances, neural networks, such as graph neural networks, generate outputs that are not easily explainable due to numerous interactions between their layers and the learned weights. This obscures the internal decision-making process, making it difficult to interpret how the network arrives at a particular output, even if the output is accurate. While the network may be trained on vast amounts of data, the intricate transformation of inputs through multiple layers means that the rationale behind any given prediction or decision is not easily traceable. For example, with respect to graph neural networks, the structure of the graph data may introduce additional layers of complexity in how information is propagated and aggregated, thereby further obscuring how the graph neural network arrives at a result.

The lack of explainability in neural networks poses significant challenges to the field of machine learning. Without understanding how a network makes its decisions, it is difficult to diagnose issues like errors, hallucinations, biases, or unexpected behavior. Being able to explain neural network outputs would not only improve the interpretability and trustworthiness of these systems, but also enable better debugging, validation, and refinement of models.

In example aspects, a graph neural network and a system that explains the graph neural network are disclosed herein. The graph neural network may be used to generate recommendations. For example, the graph neural network may perform a link prediction task, in which the graph neural network determines a likelihood of an edge between two nodes. Based on this likelihood, a recommendation may be generated. For example, if a first node is a user and a second node is a city, the graph neural network may determine a likelihood of an edge between the user and the city, and based on this likelihood, the city may be recommended to the user.

In example aspects, a recommendation explainer identifies node features and structural features of the graph-structured data to explain the reasons for which the graph neural network assigned the likelihood to the edge, which resulted in a recommendation. To do so, the recommendation explainer may perturb features of a node associated with the edge to identify relevant features, which may be features that most influenced the determination of the likelihood of the edge. Moreover, the recommendation explainer may also perturb a structure of the graph processed by the graph neural network, thereby identifying edges that were likely to have most influenced the determination of the likelihood of the edge. Using the identified relevant features and the identified relevant edges, an explanation can be derived that includes features of a node and a structure of a graph.

Aspects of the present disclosure provide various technical advantages. For example, the recommendation explainer may combine both feature and structural perturbation techniques for explaining recommendations on heterogeneous graphs, thereby providing explanations that use a more comprehensive collection of data for generating explanations, while also, in some instances, providing explanations for recommendations generated by heterogenous neural networks. Moreover, in some embodiments, explanations may be generated for a certain task of a heterogenous graph neural network, namely, link prediction.

Yet still, in some embodiments, the recommendation explainer may reduce the perturbation search space by leveraging domain-specific knowledge, such as by altering a graph prior to performing a structural perturbation, thereby offering more contextually relevant explanations in a computationally efficient manner. As set forth below, techniques of the present disclosure were empirically demonstrated to provide superior explanations as compared to previous systems. Yet still, the recommendation explainer may be integrated into various technical systems to improve the usability of such systems and to improve the way in which users interact with a graph neural network. For example, the recommendation explainer enables user-facing explanations and internal model understanding for developers. Furthermore, the system disclosed herein may handle heterogeneous graphs while providing comprehensive explanations that consider both feature and structural aspects simultaneously, which existing systems were unable to accomplish effectively. As will be apparent, these are only some of the technical advantages provided by aspects of the present disclosure.

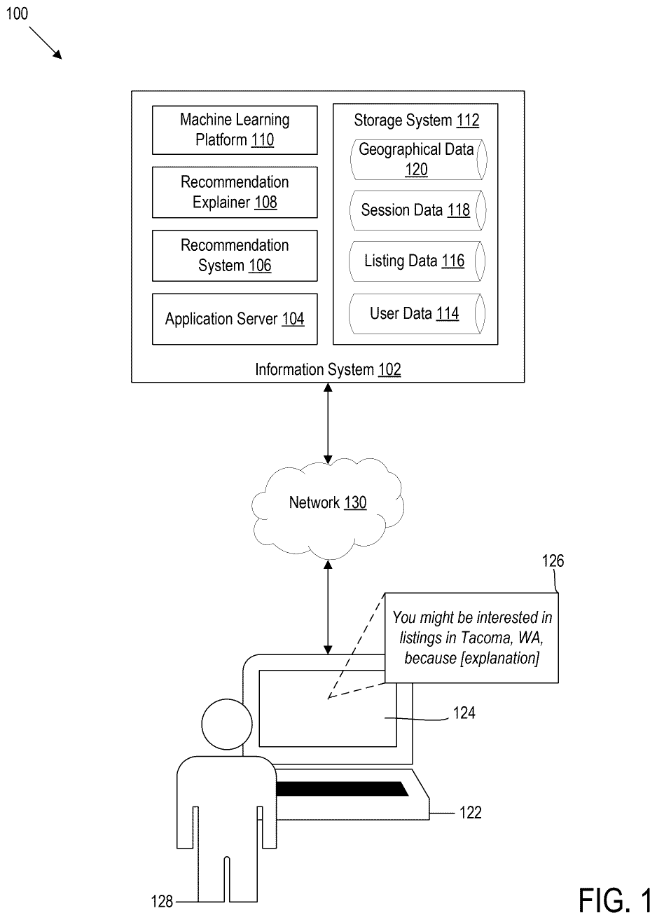

FIG. 1 illustrates an example network environment 100 in which aspects of the present disclosure may be implemented. In the example shown, the environment 100 includes an information system 102, device 122, and network 130.

The information system 102 may be a collection of software, hardware, data, and networks. The information system 102 may be associated with an organization. For example, the organization may use, develop, maintain, own, or otherwise be associated with the components of the information system 102. In some embodiments, the information system 102 is associated with a technology company or a real estate company. The information system 102 may include one or more frontend systems via which the device 122 may interact with the information system 102. The frontend systems may include a web application or a mobile application and may include user interfaces that are displayed on a browser or mobile application running on the device 122. The information system 102 may include web servers, application servers, and database servers. Some components of the information system 102 may operate in a common computing environment. Some components of the information system 102 may operate in different computing environments and communicate over a network, such as the internet or an intranet. Some components of the information system 102 may be hosted in a cloud environment. Some components of the information system 102 may be developed and maintained by a third-party (e.g., an entity different than the organization with which the information system 102 is associated).

In the example of FIG. 1, the information system 102 includes an application server 104, a recommendation system 106, a recommendation explainer 108, a machine learning platform 110, and a storage system 112. In other embodiments, the information system 102 may include more or fewer components. Furthermore, operations and features of components of the information system 102 may overlap and vary depending on the embodiment.

The application server 104 may facilitate communication with frontend components of the information system 102 or with applications external to the information system 102 that communicate with the information system 102. The application server 104 may manage, run, or provide services to applications. For example, the application server 104 may provide website content to a browser and respond to requests made by the website. Examples of other such applications are described in connection with the application 124. The application server 104 may include a plurality of APIs that may be called by frontend systems such as a mobile application or web browser. In some instances, the application server 104 may also manage user interface displays. In response to receiving a request, the application server 104 may call one or more other components of the information system 102 to handle aspects of the request. For example, the application server 104 send a request to the recommendation system 106 to generate a recommendation.

The recommendation system 106 includes one or more hardware or software components for generating a recommendation. Depending on the context in which it is implemented, the types of recommendations generated by the recommendation system 106 may vary. As one example, the recommendation system 106 may generate a recommendation for a user related to interactions with an application. For example, the recommendation system 106 may recommend that the user select, view, or otherwise interact with certain content provided by the application. For instance, if the application relates to real estate, then the recommendation system 106 may recommend that the user take an action (such as view) a certain listing or region. In some embodiments, recommendations generated by the recommendation system 106 may be represented by a graph. For example, an edge between a first node and a second node may represent a recommended action between a first entity represented by the first node and a second entity represented by the second node.

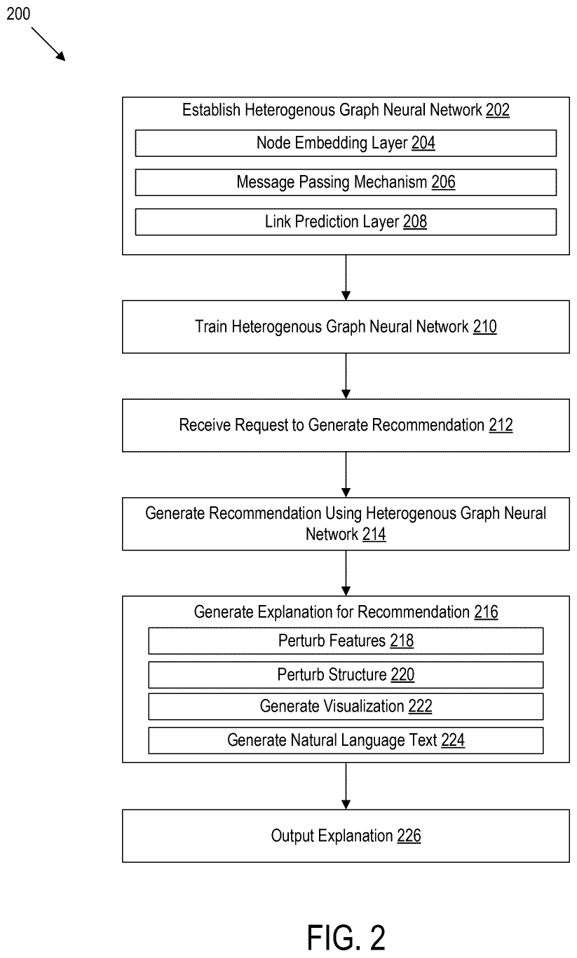

The recommendation system 106 may include, or may access, a graph neural network. To generate recommendations, the graph neural network may perform a link prediction task, in which, given a set of input data and learned parameters, the graph neural network determines a likelihood of an edge between two nodes in the graph. The edge may represent an action. If the likelihood of the edge is sufficient high, such as greater than a threshold, the action may be recommended. The graph neural network may be a heterogenous graph neural network. The graph neural network may be trained using data from the storage system 112. Example aspects of the architecture of the graph neural network, and of training and performing inference with the graph neural network, are described further in connection with FIG. 2.

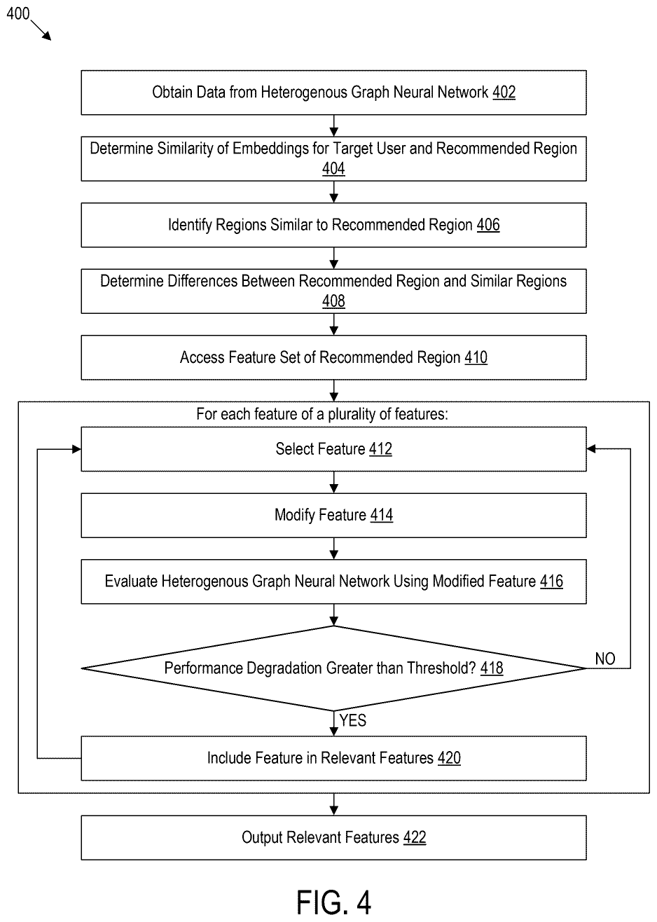

The recommendation explainer 108 may include software and hardware for analyzing the recommendation system 106 or outputs thereof. For example, the recommendation explainer 108 may analyze an output of the heterogenous graph neural network of the recommendation system 106. The recommendation explainer 108 may identify or generate data that is indicative of why the recommendation system 106 generated a certain recommendation, such as data that influenced the likelihood of an edge that corresponds to the recommendation. In some embodiments, the recommendation explainer 108 may both perturb features and a structure of a heterogenous graph used to generate a recommendation. For example, the recommendation explainer 108 may identify one or more features of one or more nodes between which an edge is predicted. As another example, the recommendation explainer 108 may determine features of a graph that was used to generate the recommendation, such as one or more edges or subgraphs that influenced the likelihood of an edge that corresponds to the recommendation. In some embodiments, the recommendation explainer 108 may generate further data that explains a recommendation, such as a visualization or natural language text that explains the recommendations. Example aspects of the recommendation explainer 108 are further described at least in connection with FIGS. 4-9.

The machine learning platform 110 may include one or more components for developing, deploying, or maintaining one or more machine learning models. Such machine learning models may include one or more graph neural networks of the recommendation system 106. As examples, the machine learning platform 110 may include hardware and software for data preprocessing, model training, and model optimization. Furthermore, the machine learning platform 110 may facilitate the deployment of trained models to production environments, enabling integration with applications or services, such as the application server 104 and recommendation system 106. Additionally, the machine learning platform 110 may include computing resources for monitoring model performance, managing versions, and scaling resources as needed, ensuring that, for example, the graph neural network of the recommendation system 106 can be efficiently maintained and updated over time.

The storage system 112 may include various components for storing and managing data. For example, the storage system 112 may include storage devices, which provide physical space for data; interfaces that connect the storage devices to other devices; and storage management software, which handles tasks like data organization, access control, and ensuring data integrity. In some embodiments, data from the storage system 112 may be used train and validate a graph neural network of the recommendation system 106. In some embodiments, aspects of the storage system 112 may be distributed while other aspects may be centralized. In some embodiments, the storage system 112 can be on-premises or cloud-based, or a hybrid of both. In some embodiments, part of the storage system 112 may be internal to an entity associated with the information system 102, whereas part of the storage system 112 may be external relative to that entity. In the example shown, the storage system 112 includes user data 114, listing data 116, session data 118, and geographical data 120.

The user data 114 may include data pertaining to users that interact with the information system 102, such as by using an application associated with the application server 104. In some embodiments, the users are human users that have used an application associated with an entity of the information system 102. Example user data 114 may include, but is not limited to, the following: identifiers; activity data on an application associated with the information system 102; geographical data; biographical data; real estate data associated with users, such as property owned by or otherwise associated with a user; links to other users; session data; or other data. In some embodiments, at least some of the user data 114 is used as initial features for nodes of a user node type of a heterogenous graph neural network of the recommendation system 106.

The listing data 116 may include data pertaining to real estate. For example, the listing data 116 may include property that is for sale. The property may include land, houses, condos, apartments, commercial buildings, or other types of property. Example listing data 116 may include, but is not limited to, the following: price; location, which may include geographical coordinates, region, municipality, or other representations of location; square footage; number of bedrooms; number of bathrooms; year built; sales history; features of the property, such as whether the property has waterfront, the type of heating, whether the property has a basement, whether the property has a fireplace, construction materials, features pertaining to a garage, upgrades to the property, or other features of the property; visual information, such as photos; textual information, such as descriptions or legal information pertaining to the property; or other property data. Depending on the type of data, the format of the data may vary. For example, certain features may be represented as numbers, such as the square footage, number of bedrooms, number of bathrooms, and year built, whereas other data may be represented as a Boolean, such as whether the property has a certain feature. In some embodiments, at least some of the listing data 116 is used as initial features for nodes of a listing node type of a heterogenous graph neural network of the recommendation system 106.

The session data 118 may include data pertaining to activity on an application associated with the information system 102. For example, if the application is a website, then the session data 118 may include data for a user session with the website. Example session data 118 may include, but is not limited to, the following: session identifier; a user identifier associated with a session, such as a user of the user data 114; a time of the session; a location from which the session was initiated; web pages or web resources associated with the session; links to other sessions, such as previous sessions of the same user, or other data. Additionally, for a given session, the session data 118 may include one or more actions associated with the session. An action may include an action type, an entity that performed the action, and an object of the action. In some instances, the entity that performed the action may be a user and the object of the action may be a listing. There may be various action types, such as view, save, favorite, play, like, message, select or de-select, edit, upload, download, or another action type. In some embodiments, the session data 118 may be used as part of training a heterogenous graph neural network. For example, actions of the session data 118 may correspond to at least some of the edges used by heterogenous graph neural network.

The geographical data 120 may include location data for properties of the listing data 116 or users of the user data 114. The location data may include geographical regions within which listings of the listing data 116 may be located. A geographical region may be, for example, a set of geographical coordinates, a city or municipality, a country, a county, a neighborhood, or another type of region.

The device 122 may be a computing device. The device 122 may be a laptop, phone, tablet, smart device, virtual reality headset, IoT device, a collection of computing devices, or another type of computing device. The device 122 may be communicatively coupled with components of the information system 102 via the network 130. The device 122 may execute or access an application 124.

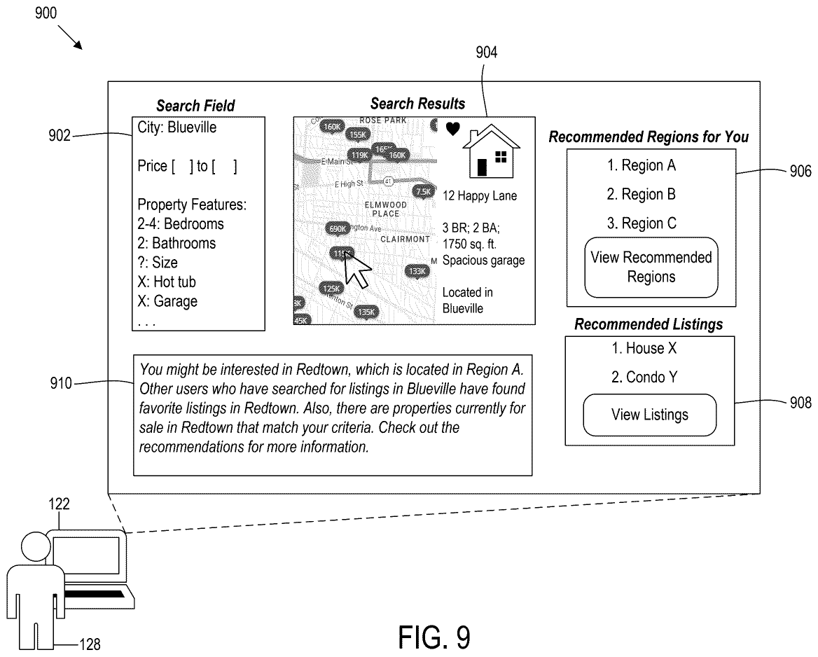

The application 124 may be a software program that is associated with the information system 102 and may be part of the information system 102. For example, the application 124 may be a web browser useable to access a web application of the information system 102. As another example 124, the application 124 may be an application provided by an entity associated with the information system 102 that is downloaded onto the device 122. In some embodiments, the application 124 is a native mobile application. As one example, the application 124 may be a service for, among other things, searching, viewing, listing, or purchasing real estate. The application 124 may include input fields via which users may search for or interact with property, and the application 124 may include output fields for displaying information associated with property. In some embodiments, the application 124 displays a recommendation generated by the recommendation system 106, as illustrated by the example recommendation 126. As another example, the application 124 may not be a customer facing application and may instead be a program for evaluating a performance of the heterogenous graph neural network. For example, the application 124 may enable a user to view and interact with data output by the recommendation explainer 108 that indicates why the heterogenous graph neural network generated a recommendation. Example aspects of the application 124 are illustrated and described in connection with FIG. 9.

The recommendation 126 is an example output of the application 124. Data for the recommendation 126 may be generated by the recommendation system 106. The recommendation 126 indicates that the user 128 may be interested in listings in a certain geographical region. Further the recommendation 126 includes an explanation. The explanation may be based on data output by the recommendation explainer 108. For example, the explanation may include data pertaining to one or more features of the user 128, users similar to the user 128, listings associated with the user 128, session data associated with the user 128, or other data that is identified or generated by the recommendation explainer 108.

The user 128 may be an entity that is interacting with the application 124. In some embodiments, the user 128 is a person. In other embodiments, the user 128 may be another software program. The user 128 may be associated with one or more entries in the user data 114. Although FIG. 1 illustrates a single user 128, there may be a plurality of users that access the information system 102 and that perform operations that are described herein as performed by the user 128. One or more of the plurality of users may use a different type of computing device, and the plurality of users may access aspects of the information system 102 simultaneously.

The network 130 may communicatively couple components of the network environment 100. In the example shown, the network 130 communicatively couples the device 122 with components of the information system 102. The network 130 may be, for example, a wireless network, a wired network, a virtual network, the internet, or another type of network. Furthermore, the network 130 may include subnetworks, and the subnetworks may be different types of networks or the same type of network.

FIG. 2 is a flowchart of an example method 200. The method 200 may include steps associated with generating a recommendation, such as a recommendation for the application 124. Steps of the method 200 may be performed by components of the information system 102.

In the example shown, the recommendation system 106 may establish a heterogeneous graph neural network (step 202). The heterogenous graph neural network may be a graph neural network that includes different node types, different edge types, or both different node types and different edge types. In some embodiments, the heterogenous graph neural network is a bi-partite graph in which nodes of the same type do not include edges between them. In some embodiments, edges of the heterogenous graph neural network are bi-directional. In some embodiments, the node types include one or more of the following: a user node type; a listing node type; and a geographical region node type. In some embodiments, the edge types include one or more of the following: a view edge type; a save edge type; a favorite edge type; a contain edge type; and a user-region edge type. The heterogeneous graph neural network may include a node embedding layer 204, a message passing mechanism 206, and a link prediction layer 208.

During training and inference, the heterogenous graph neural network may receive a heterogenous interaction graph. The interaction graph may be, for example, a training sample, or a set of data for which a prediction is to be made. The interaction graph may be constructed using data of the storage system 112.

Formally, the interaction graph may be G=(V, E), where:
V represents the set of nodes
E⊆V XV denotes the set of edges that encode interactions, such as user->view->listing, or region->contains->listing.

Each edge e∈E is associated with a type τ (e), representing the nature of the relationship between two nodes. Formally, the heterogeneous interaction graph is defined as: G=(Vᵤ ∪Vₗ ∪Vᵣ, Eᵤₗ∪Eᵣₗ ∪Eᵤᵣ), where Vᵤ, Vₗ, and Vᵣ represent the sets of user, listing, and region nodes, respectively. Eᵤₗ corresponds to interactions between users and listings, Eᵣₗ captures relationships between regions and listings, and Eᵤᵣ captures relationships between users and regions.

A primary task of the recommendation system 106 may be to predict the likelihood of a link between a user u∈Vᵤ and a region r∈Vᵣ based on observed interactions and the graph structure. This is formalized as a link prediction problem: ŷᵤᵣ=f_{θ}(u, r, G), where f_{θ} is the link prediction model parameterized by θ, and ŷᵤᵣ is the predicted likelihood of an interaction between user u and region r.

The node embedding layer 204 may be an initial layer of the heterogenous graph neural network. The node embedding layer 204 may be trained to map feature vectors associated with initial node features to a shared embedding space. For example, because the heterogenous graph neural network includes different node types, the initial features of nodes may differ depending on the node type. For a given node, the node embedding layer 204 may apply a node type-specific transformation to a feature vector for the node so that all feature vectors for all nodes across all node types of the graph are mapped to a shared vector space, thereby enabling data to be shared between nodes and enabling comparisons of nodes. For example, each node v∈V is mapped to a dense vector representation hᵥ ∈R^{d} using the node embedding layer 204. The initial embeddings are learned from the node features and are iteratively updated during the training process.

The message passing mechanism 206 may include multiple layers in which node data is updated. For example, each node v∈V may aggregate information from its neighbors N(v) through a learnable function.

The node update rule for the t-th layer may be defined as:

$${h}_{v}^{( t + 1 )} = AGG ( {h}_{v}^{( t )} , {h}_{u}^{( t )} : u ∈ N ( v ) )$$

AGG is an aggregation function such as sum, mean, or attention-based pooling. hᵥ may be an embedding for the node v, and hᵤ may be an embedding for the node u. Such multi-hop message passing may enable the graph to capture higher-order dependencies between nodes. In some embodiments, the message passing mechanism 206 includes a two-layer design, where each layer performs graph convolutions over different relationship types. For each relationship, such as for each edge type, the heterogenous graph neural network may include a separate graph convolutional layer and apply type-specific linear transformations to incorporate edge-specific features into the convolution process. Additionally, self-loop embeddings may be refined using residual connections for each node type, ensuring that the node's initial features are preserved alongside learned representations. This structure allows the heterogenous graph neural network to aggregate information across the graph, dynamically updating node embeddings while addressing the unique characteristics of heterogeneous relationships.

The link prediction layer 208 may be a layer that determines a likelihood of an edge, which may be used to generate a recommendation. In some embodiments, the link prediction layer 208 may determine a similarity between node embeddings at a source and target node of an edge. This may be performed for each edge type. During this process, the link prediction layer 208 may score edges by using the learned node features (h) from the heterogenous graph neural network, which encapsulate the structural and relational context of each node in the graph. For example, the link prediction layer 208 may include a scoring function that computes the likelihood of an edge using

$${\hat{y}}_{ul} = σ ( {h}_{u}^{T} {Wh}_{l} ) ,$$

where σ is the sigmoid function and W is a learnable weight matrix.

In the example shown, the recommendation system 106 may train the heterogenous graph neural network (step 210). In some embodiments, the heterogenous graph neural network may be trained using supervised learning techniques where labeled training data is generated using data from the storage system 112. As one example of a training sample of the training data, the recommendation system 106 may generate an interaction graph using data from one or more of the user data 114, the listing data 116, the session data 118, and the geographical data 120. The interaction graph may represent actual historical activity on the application 124.

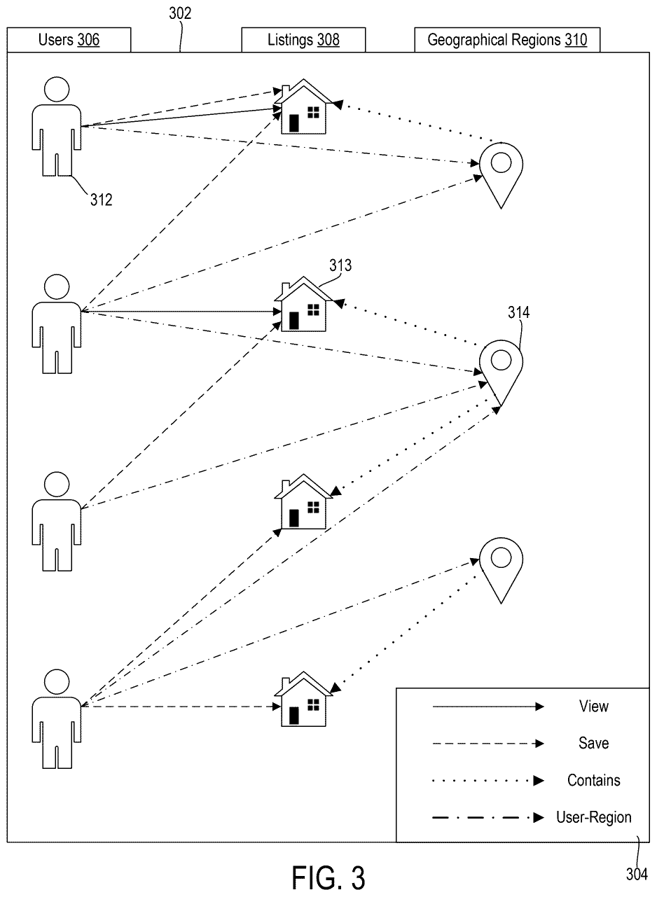

For example, the ground truth for training and evaluating may be derived from historical user interactions with listings on the platform. For example, the session data 118 may provide labels for whether a user u has engaged with a listing l (e.g., viewed, saved, and favorited), resulting in positive examples for link prediction. Additionally, links between users and regions may be inferred using the geographical data 120. For example, if a user interacted with a listing in a certain region, then a link may be added between the user and the region. An example of such an interaction graph is illustrated in FIG. 3. As shown, the interaction graph may include node and edge types as established for the heterogenous graph neural network according to the data retrieved from the storage system. Additionally, the training data may also include negative samples. For example, negative examples may be defined by selecting user-listing pairs that have no recorded interaction. Formally, let Y⊆Vᵤ× Vₗ be the set of observed interactions (positive examples) from the storage system 112, and Y′⊆Vᵤ×Vₗ be the set of sampled negative examples. The training set T is constructed as T={(u, l,yul)| (u, l)∈Y∪Y′, where labels yᵤₗ=1 if (u, l)∈Y and yᵤₗ=0 if (u, l)∈Y′.

In the example shown, the recommendation system 106 may receive a request to generate a recommendation (step 212). For example, the recommendation system 106 may be communicatively coupled with the application 124, which may provide a request to the recommendation system 106 to generate a recommendation in real time for a user, such as the user 128 of the application 124. As another example, the recommendation system 106 may generate batch recommendations, in which the recommendation system 106 generates recommendations for a plurality of historical users. In addition to receiving a request to generate a recommendation, the recommendation system 106 may receive input data. The input data may include user data 114, listing data 116, session data 118, or geographical data 120 from one or more of the storage system 112 or the application server 104. The input data may be transformed into an interaction graph to be provided to the heterogenous graph neural network.

In the example shown, the recommendation system 106 may generate a recommendation using the heterogenous graph neural network (step 214). For example, the node embedding layer 204 may be applied to generate embeddings for the plurality of nodes of the input data. The message passing mechanism 206 may be applied to update the node embeddings. The link prediction layer 208 may be applied to determine likelihoods of edges between nodes. Based on the likelihoods, the recommendation system 106 may generate a recommendation. For example, the recommendation system 106 may recommend a region to a user. To do so, the recommendation system 106 may identify an edge most likely to exist between that user and a region. As another example, the recommendation system 106 may recommend a region to a user if the likelihood that an edge exists between the user and the region is greater than a threshold. The threshold may be, for example, a minimum value, such as 0.5, 0.8, or another value. As another example, the threshold may be relative to the likelihood of other edges. For example, if an edge is more likely to exist than any other edge leading from that node, or is within a top number of most likely to exist edges from that node, then the likelihood may be greater than a threshold and the region may therefore be recommended.

Additionally, the recommendation may be for other edge types of the heterogenous graph neural network. For example, the recommendation system 106 may recommend a listing to a user by determining a likelihood of an edge between the user and the listing. Moreover, in some instances, the recommendation system 106 may recommend a type of action to a user. For example, the heterogenous graph neural network may determine likelihoods of existence of different types of edges between a set of nodes. In such circumstances, an action associated with an edge type with the highest likelihood may be recommended. In some embodiments, the recommendation system 106 may generate multiple recommendations. For example, by predicting edges across the heterogenous graph neural network, as opposed to only evaluating edges associated with a certain user, the recommendation system 106 may generate recommendations for a plurality of different users. As another example, for a given user node, the recommendation system 106 may select the top X number of edges that have the highest likelihoods of edges involving the user node, and X number of recommendations may be generated based on those identified edges.

In the example shown, the recommendation explainer 108 may generate an explanation for the recommendation generated by the heterogeneous graph neural network (step 216). In some embodiments, the recommendation explainer 108 may automatically generate an explanation for a recommendation generated by the recommendation system 106. In some embodiments, the recommendation explainer 108 may receive data corresponding to the heterogenous graph neural network used to generate the recommendation. For example, the recommendation explainer 108 may receive the interaction graph used by the heterogenous graph neural network. In some embodiments, the recommendation explainer 108 receives a final state of the embeddings of the nodes of the graph. Additionally, the recommendation explainer 108 may receive data from the storage system 112 that was used by the heterogenous graph neural network to generate recommendations. In the example shown, generating an explanation for the recommendation includes perturbing features (step 218), perturbing a structure (step 220), generating a visualization (step 222), and generating a natural language explanation (step 224). However, generating the explanation may include more or fewer steps than the steps 218-224 illustrated in the example of FIG. 2.

In the example shown, the recommendation explainer 108 may perturb features (step 218). By perturbing features, the recommendation explainer 108 may identify relevant features of a node associated with an edge that was predicted by the heterogenous graph neural network. The relevant features may be features that most influenced the likelihood of the edge. For example, if the recommendation is a recommendation of a region to a user, then the relevant features may include features of one or more of the user or the region. An example method for perturbing features is described in connection with FIG. 4.

In the example shown, the recommendation explainer 108 may perturb a structure of the heterogenous graph (step 220). By perturbing the graph structure, the recommendation explainer 108 may identify relevant edges of a subgraph of the graph. The relevant edges may represent links in the graph that most influenced the likelihood of the predicted edge. In some embodiments, perturbing the structure of the graph may only use the relevant features identified in the step 218, thereby combining feature and structural perturbation to generate explanations that incorporate both node-specific characteristics and relational characteristics.

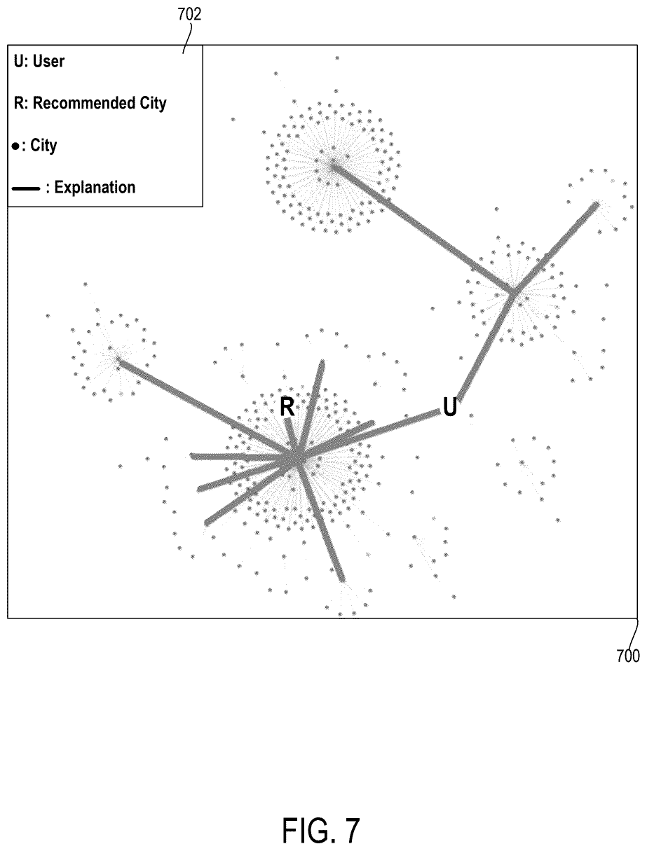

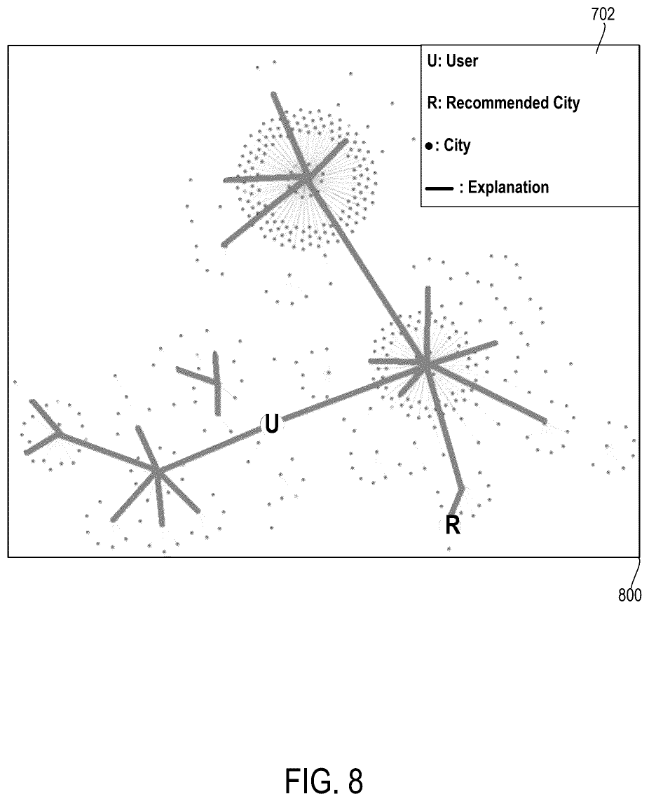

In the example shown, the recommendation explainer 108 may generate a visualization to explain the recommendation (step 222). For example, using one or more of the relevant features or relevant edges, the recommendation explainer 108 may generate a visualization. The visualization may, for example, emphasize the relevant features or edges. In some embodiments, the visualization includes a subgraph that highlights or bolds the relevant edges. Example visualizations are illustrated in FIGS. 7-8.

In the example shown, the recommendation explainer 108 may generate a natural language explanation (step 224). As one example, the recommendation explainer 108 may identify text associated with the relevant features and output the text. As another example, the recommendation explainer 108 may input one or more of the recommendation, nodes associated with the recommendation, text associated with the relevant features (e.g., a type of feature and corresponding feature values), text associated with the relevant edges (e.g., edge types, edge weights, etc.), and a prompt into a large language model to generate natural language text explaining the recommendation.

In the example shown, the recommendation explainer 108 may output the explanation (step 226). For example, the recommendation explainer 108 may provide the explanation to one or more of the recommendation system 106, the application server 104, or the application 124. Depending on the embodiment, the form of the explanation may vary. For example, the explanation may include an identification of or data associated with the relevant features and edges. As other examples, the explanation may include a visualization or a natural language text response generated by a large language model. Combinations of such outputs are likewise possible.

FIG. 3 illustrates an example graph 302. The graph 302 may be an example of an interaction graph that may be used by the heterogeneous graph neural network during training or inference. The graph 302 may represent data from the storage system 112. As will be understood, the graph 302 is not limited to the node and edge types illustrated in the example of FIG. 3.

In the example shown, the graph 302 includes three node types: users 306; listings 308; and geographical regions 310. In the example shown, there are four user nodes, four listing nodes, and three geographical region nodes. Each node of the graph 302 may be represented by embeddings. The initial embeddings may be generated by the node embeddings layer 204 and then be updated by the message passing mechanism 206, each of which are described above. For a user node, the initial attributes provided to the node embeddings layer 204 to generate the initial embeddings may include a session id or other data from the user data 114. For a listing node, the initial attributes provided to the node embeddings layer 204 to generate the initial embeddings may include one or more of a number of bedrooms, a number bathrooms, year built, square footage, price, days on the market, floors, whether the listing has one or more certain features, location data, or other data from the listing data 116. For a geographical region node, the initial attributes provided to the node embeddings layer 204 to generate the initial embeddings may include one or more of location data of the region, an average number of bedrooms for listings in the region, an average number of bathrooms for listings in the region, an average year built for listings in the region, an average square footage of listings in the region, or other data of the storage system 112.

In the example shown, the graph 302 includes four edge types, as indicated by the key 304: a view edge type; a save edge type; a contains edge type; and a user-region edge type. The view and save edge types represent actions taken by a user relative to a listing. For example, the view edge type may indicate that the user selected or viewed content associated with the listing via an application. The save edge type may indicate that the user took a more specialized action relative to the listing, such as saving it to a user profile. The edge types between users 306 and listings 308 may be derived from the session data 118, which may track user actions relative to listings. The contains edge type may indicate that a listing is located within the bounds of a geographical region and may be inferred by using the geographical data 120 and listing data 116. The user-region edge type between a given user and a given geographical region may indicate that there is an edge between the given user and a given listing that is contained by the given geographical region. In some embodiments, the user-region edges are inferred based on the existence of edges between users and listings, and between listings and geographical regions.

Regarding training, the graph 302 may be a training sample used as part of a supervised learning process, example aspects of which are described above in connection with the step 210 of FIG. 2. For example, a ground truth for training a link prediction task may include an edge illustrated in the graph 302, such as an edge between a user node and listing node, or an edge between a user node and geographical region node. Such an edge may be associated with a positive sample. Additionally, a negative sample may also be derived from the graph 302 by selecting a user-listing or user-region pairing for which an edge does not exist and using the lack of an edge as a training label, in which the heterogenous graph neural network may be trained to determine that the likelihood of that edge is low.

Regarding inference, the graph 302 may represent data retrieved by the recommendation system 106 from which to generate a recommendation. As an example, the heterogenous graph neural network may process the data using the graph topology set forth in the graph 302, the attributes of entities associated with the nodes in the graph 302, and learned weights. As a result, the heterogenous graph neural network may determine a likelihood of an edge between, for example, the user 312 and the listing 313 or between the user 312 and the geographical region 314. Based in part on this likelihood, the recommendation system 106 may recommend the listing 313 or region 314 to the user 312, and the recommendation explainer 106 may explain the recommendation by providing features of the listing 313 or region 314 that caused the recommendation, or may indicate that, because other users with similar activity or features are linked to the listing 313 and the region 314, the user 312 may likewise be interested in the listing 313 or the region 314.

FIG. 4 is a flowchart of an example method 400 that may be performed by the recommendation explainer 108 as part of perturbing features (step 218) to generate an explanation. Although the method 400 is described with perturbing features as part of generating an explanation with respect to a single target user and a single recommended region, the method 400 and the steps thereof are not limited to a single recommendation. For example, the method 400 may be applied, in parallel or sequentially, for a plurality of recommendations, including multiple recommendations for a single user or multiple recommendations for a plurality of users. Further, the method 400 and steps thereof are not limited to recommendations between a user and region, and may also be applied to identify relevant features for recommendations between a user and listing, or for different types of edges.

In the example shown, the recommendation explainer 108 may obtain data from the heterogenous graph neural network of the recommendation system 106 (step 402). For example, the recommendation explainer 108 may obtain an interaction graph and data associated with the nodes and edges of the interaction graph. Additionally, the recommendation explainer 108 may obtain final node embeddings generated by the heterogenous graph neural network. Further, the recommendation explainer 108 may obtain one or more recommendations, such as predicted edges, generated by the recommendation system 106.

In the example shown, the recommendation explainer 108 may determine a similarity of embeddings for a target user and a recommended region (step 404). The target user may be a user to whom a recommendation is made. The target user may be represented by a graph node of a user type, and the recommended region may be represented as a graph node of a geographical region type. The recommended region may be a geographical region that was recommended to the target user. The recommendation may be represented by an edge between the target user and the geographical region that was predicted by the recommendation system 106 based on a likelihood of an edge between the target user and the recommended region generated by the heterogenous graph neural network. To determine the similarity of the embeddings of the target user and the recommended region, the recommendation explainer 108 may determine a cosine similarity of their respective embeddings.

In the example shown, the recommendation explainer 108 may identify similar regions to the recommend region (step 406). For example, the recommendation explainer 108 may retrieve the k closest regions Rₖ to the recommended region rₜ based on cosine similarity of the embeddings of the recommended region to the embeddings of respective embeddings of the other regions.

In the example shown, the recommendation explainer 108 may determine differences between the recommended region and the identified similar regions (step 408). For example, the recommendation explainer 108 may determine the difference in the raw features of the recommended region rₜ, denoted as Xᵣₜ, compared to the raw features of the average feature vector of the regions similar to the recommended region Rₖ. For example, the recommendation explainer 108 may determine the difference using the following:

$$Δ {x}_{rt} = {x}_{Rk} - {x}_{rt} , {x}_{Rk} = \frac{1}{\vert {R}_{k} \vert} {\sum }_{{r}_{i} ∈ {R}_{k}} {x}_{ri}$$

In the example shown, the recommendation explainer 108 may access a feature set for the recommended region (step 410). The feature set may include data pertaining to the region itself, such as location data and features of the area associated with the region. The feature set may include features associated with listings contained in the region. As an example, the recommendation explainer 108 may access data from the storage system 112 pertaining to the recommended region. As another example, the recommendation explainer 108 may access the attributes used to generate initial embeddings for the recommended region. For example, the feature set may include one or more of location data of the region, an average number of bedrooms for listings in the region, an average number of bathrooms for listings in the region, an average year built for listings in the region, an average square footage of listings in the region, or other data.

Having accessed the feature set, the recommendation explainer 108 may identify one or more relevant features from the feature set. The relevant features may be a subset of the feature set. In some embodiments, the relevant features may be the features of the feature set that most impacted the final embeddings associated with the region or user. In some embodiments, the relevant features may be the features of the feature set that had the most impact on determining the likelihood of an edge between the recommended region and the target user.

As described in connection with the steps 412-420, the recommendation explainer 108 may iteratively evaluate features to identify the relevant features. For example, the recommendation explainer 108 may perform the operations 412-418 for each feature of a plurality of features, which may be a plurality of features selected from the feature set. In some embodiments, the recommendation explainer 108 may evaluate multiple features in combination at the same time, as opposed to just a single feature. In some embodiments, the features are represented as embeddings that are selected and evaluated.

In the example shown, the recommendation explainer 108 may select a feature (step 412). For example, the recommendation explainer 108 may select a feature that has not yet been evaluated. As an example, the recommendation explainer 108 may select an “average year built” feature of the recommended region.

In the example shown, the recommendation explainer 108 may modify the feature (step 414). By modifying the feature, the recommendation explainer 108 may distort the feature such that it does not represent an actual value for the recommended node. Depending on the data type of the feature, the modification may vary. For example, if the feature is a numerical value, it may be set to a very high or low number; if the feature is a Boolean, then it may be flipped from True to False, or False to True; if the feature is selected from a pre-defined list of options, a different option may be selected. Continuing with the above example, if the “average year built” of the recommended region is 1955, it may be modified to be 9999, or another value. In some embodiments, the recommendation explainer 108 may modify one or more specific indices of an embeddings feature vector that represents the recommended region. Though a value of the selected feature may be modified, values of other features of the recommended region may be maintained.

In the example shown, the recommendation explainer 108 may evaluate the heterogenous graph neural network using the modified feature (step 416). For example, the performance of the heterogenous graph neural network may be measured using one or more of Normalized Discounted Cumulated Gain (nDCG), Precision, or Recall of the heterogenous graph neural network that uses the modified feature. In some embodiments, determining the performance of the heterogenous graph neural network may include using the average feature vector of the similar regions or using the difference between the average feature vector of the similar regions and the feature vector of the recommended region.

In the example shown, the recommendation explainer 108 may determine whether a performance degradation of the heterogenous graph neural network is greater than a threshold (step 418). For example, the recommendation explainer 108 may compare a performance measured at the step 416 with a baseline performance of the heterogenous graph neural network, such as a performance of the heterogenous graph neural network when the feature value is not modified. If the degradation of the performance of the heterogenous graph neural network caused by using the modified feature value is greater than a threshold, then it may be determined that the feature is sufficiently impactful to be included in the relevant features (e.g., taking the “YES” branch). If the degradation of the performance of the heterogenous graph neural network caused by using the modified feature value is less than a threshold, then it may be determined that the feature is not sufficiently impactful to be included in the relevant features (e.g., taking the “NO” branch).

In some embodiments, the threshold value may be a change in a particular performance metric. For example, if performance for one or more of nDCG, precision, or recall was reduced by a certain percentage (e.g., 10%, 50%, or another value), then it may be determined that performance degradation is greater than a threshold. In some embodiments, the threshold may be relative to the performance degradation caused by modifying the feature value relative to modifying other features. For example, if modifying a given feature causes a greater performance degradation than modifying any other feature, or a greater degradation than a certain number of other features, then the performance degradation may be considered to be greater than the threshold. In some embodiments, an administrator of the recommendation explainer 108 may set the threshold value, whereas in some embodiments, it may be automatically learned by the recommendation explainer 108.

In response to taking the “NO” branch, the recommendation explainer 108 may return to the step 412 to select another feature. In response to taking the “YES” branch, the recommendation explainer 108 may include the selected feature in the set of relevant features (step 420). The recommendation explainer 108 may then return to the step 412 to select another feature. Additionally, as part of returning to the step 412, the modified feature value for the previously selected feature value may be reverted to a default value.

In the example shown, the recommendation explainer 108 may output the relevant features (step 422). For example, once the recommendation explainer 108 has evaluated each feature of the plurality of features, the recommendation explainer 108 may output the relevant features. The recommendation explainer 108 may output an identification of the relevant features. The recommendation explainer 108 may output associated values of the relevant features.

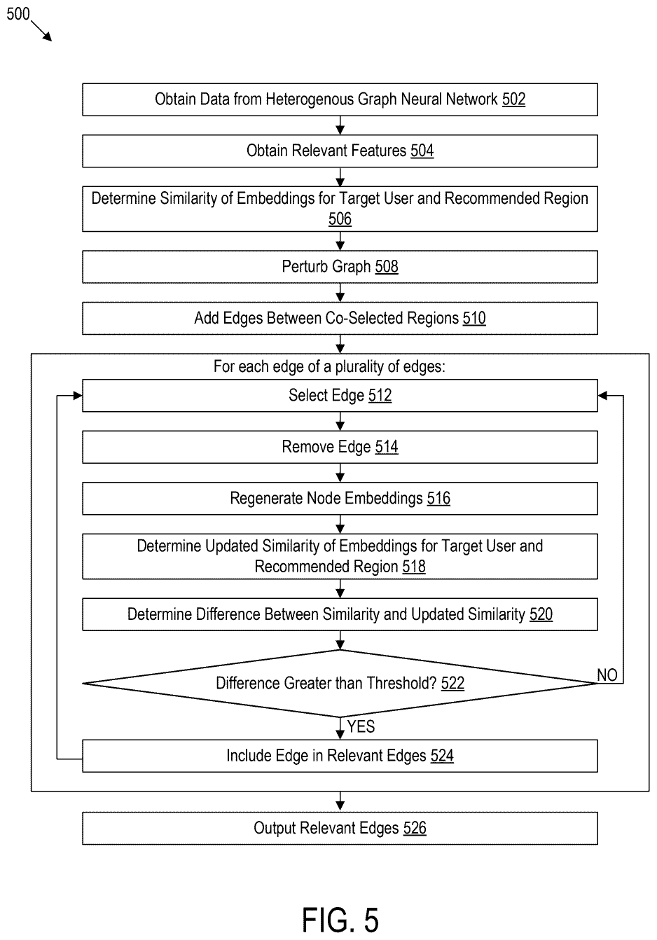

FIG. 5 is a flowchart of an example method 500 that may be performed by the recommendation explainer 108 as part of perturbing the graph structure (step 220) to generate an explanation. Although the method 500 is described with perturbing the graph structure as part of generating an explanation with respect to a single target user and a single recommended region, the method 500 and the steps thereof are not limited to a single recommendation. For example, the method 400 may be applied, in parallel or sequentially, for a plurality of recommendations, including multiple recommendations for a single user or multiple recommendations for a plurality of users. Further, the method 500 and steps thereof are not limited to recommendations between a user and region, but may also be applied to identify relevant edges or subgraphs for recommendations between a user and listing, or for different types of edges.

In the example shown, the recommendation explainer 108 may obtain data from the heterogenous graph neural network (step 502), example aspects of which are described in connection with the step 402 of FIG. 4.

In the example shown, the recommendation explainer 108 may obtain relevant features (step 504). For example, the recommendation explainer 108 may obtain any data processed by or generated by the recommendation explainer 108 during the method 400 described in connection with FIG. 4. For example, the recommendation explainer 108 may obtain relevant features for one or more of a user, listing, or region associated with the recommendation. In some embodiments, the recommendation explainer 108 may obtain relevant features identified as part of the method 400. For example, the recommendation explainer 108 may obtain relevant features of a recommended region node. The features may be one or more features used as part of generating initial embeddings for the recommended region node. In some embodiments, the recommendation explainer 108 may use the relevant features to perturb the graph structure. For example, the relevant features may be used to generate initial node embeddings. As another example, for the recommended region, or for all geographical region node types, only the relevant features may be used and features that were not included in the set of relevant features may not be used.

In the example shown, the recommendation explainer 108 may determine a similarity of embeddings for a target user and a recommended region (step 506), example aspects of which are described above in connection with the step 404.

In the example shown, the recommendation explainer 108 may perturb the heterogenous graph neural network (step 508). For example, from the heterogeneous graph, a user-region graph Gₕ is created by collapsing all user-region relationships and removing intermediate nodes (e.g., listings). As a result, a graph may be generated that only includes user nodes, region nodes, and edges between the user nodes and region nodes. Furthermore, a k-hop subgraph

$${G}_{u}^{k}$$

centered around the target user u is then extracted. The graph

$${G}_{u}^{k}$$

may include both direct relationships between the user and regions, and indirect relationships between users and regions.

In the example shown, the recommendation explainer 108 may add edges to co-selected regions (step 510). For example, for the subgraph

$${G}_{u}^{k} ,$$

pairs of nodes (rᵢ, rⱼ) that share a common predecessor user up are identified. Edges may be added between such nodes. In some embodiments, these relationships represent co-selected regions, in that there is a user that selected each of the regions, thereby indicating that a user interested in one or more attributes of one of the regions may also be interested in one or more attributes of the other region, further indicating that the regions may have a degree of similarity. In some instances, however, the similarity between the nodes may not be readily apparent to a recommendation system, but may be apparent to the user that selected both regions. Accordingly, by adding edges between co-selected regions, similarities may be captured and represented in the graph that may otherwise have gone unnoticed.

The recommendation explainer 108 may identify one or more relevant edges of the heterogenous graph. By doing so, the recommendation explainer may uncover graph edges and relationships critical to the model's predictions. The relevant edges may be a subset of edges of the received graph or of the subgraph

$${G}_{u}^{k} .$$

In some embodiments, the relevant edges may be the edges of the graph edges that most impacted the final embeddings associated with the region or user. In some embodiments, the relevant edges may be the edges that had the most impact on determining the likelihood of an edge between the recommended region and the target user.

As described in connection with the steps 512-524, the recommendation explainer 108 may iteratively evaluate edges to identify relevant edges. For example, the recommendation explainer 108 may perform the operations 512-522 for each edge of a plurality of edges, which may be a plurality of edges selected from the subgraph

$${G}_{u}^{k}$$

with edges added between co-selected nodes at the step 510. In some embodiments, the recommendation explainer 108 may evaluate multiple edges in combination at the same time, as opposed to just a single edge.

In the example shown, the recommendation explainer 108 may select an edge to evaluate (step 512). In some embodiments, the recommendation explainer 108 may only select certain types of edges. For example, the recommendation explainer 108 may select edges leading from the target user or edges between co-selected regions. In some embodiments, the recommendation explainer 108 may select any edges in the modified subgraph

$${G}_{u}^{k}$$

determined at the step 510.

In the example shown, the recommendation explainer 108 may remove the selected edge (step 514). For example, the recommendation explainer 108 may remove the selected edge from the subgraph

$${G}_{u}^{k} .$$

In the example shown, the recommendation explainer 108 may regenerate node embeddings for the target user and the recommended region (step 516). For example, the recommendation explainer 108 may apply the heterogenous graph neural network, without using the edge that was removed in the step 514, to regenerate embeddings for the target user and the recommended region.

In the example shown, the recommendation explainer 108 may determine an updated similarity of embeddings for the target user and the recommended region (step 518). For example, the recommendation explainer 108 may determine a similarity between the regenerated node embeddings at the step 516 for the target user and the recommended region. To do so, the recommendation explainer 108 may perform the same similarity operation that was performed at the step 506. For example, the recommendation explainer 108 may determine a cosine similarity between the regenerated embeddings for the target user and recommended region.

In the example shown, the recommendation explainer 108 may determine a difference between the similarity generated at the step 506 with the updated similarity generated at the step 518 (step 520). For example, the recommendation explainer 108 may subtract the similarity generated at the step 506 from the updated similarity generated at the step 518 and determine an absolute value of the difference. As a result, the recommendation explainer 108 may determine the impact that removing the selected edge has on the final similarity of embeddings between the target user and the recommended region.

In the example shown, the recommendation explainer 108 may determine whether the difference determined at the step 520 is greater than a threshold (step 522). In some embodiments, the threshold is a value, such as 0.2, 0.5, 1.0, or another value. In some embodiments, the threshold may be relative to the difference in similarity between the embeddings caused by removing other edges of the plurality of edges. For example, if removing a given edge causes a greater difference in node similarity than removing another edge, or causes a greater difference than removing a certain number of other edges, then the difference may be considered greater than the threshold. In some embodiments, an administrator of the recommendation explainer 108 may set the threshold value, whereas in some embodiments, it may be automatically learned by the recommendation explainer 108.

In response to taking the “NO” branch, the recommendation explainer 108 may return to the step 512 to select another edge. In response to taking the “YES” branch, the recommendation explainer 108 may include the selected edge in the set of relevant edges (step 524). The recommendation explainer 108 may then return to the step 512 to select another edge. Additionally, the previously selected edge may be added back to the subgraph

$${G}_{u}^{k} .$$

In the example shown, the recommendation explainer 108 may then output the relevant edges (step 526). For example, once the recommendation explainer 108 has evaluated each edge of the plurality of edges, the recommendation explainer 108 may output the relevant edges. The recommendation explainer 108 may output an identification of the relevant edges. The recommendation explainer 108 may output associated values of the relevant edges, such as weights, edge types, or other values.

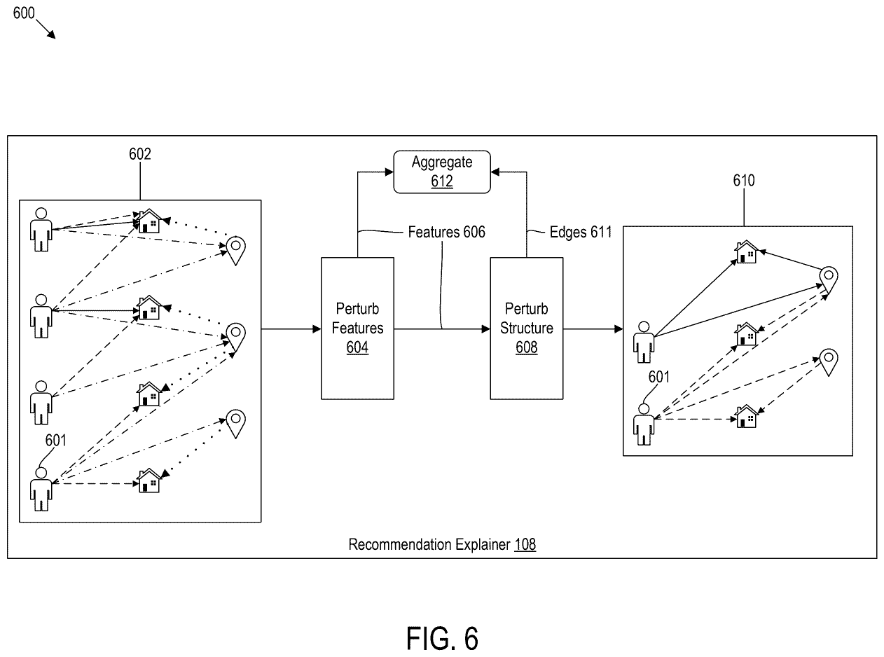

FIG. 6 illustrates an example diagram 600 illustrating a schematic representation of operations that may be performed by the recommendation explainer 108.

In the example shown, the recommendation explainer 108 may receive the interaction graph 602, example aspects of which are described in connection with the graph 302 of FIG. 3. For example, the recommendation system 106 may have generated a recommendation pertaining to the interaction graph 602, such as a recommendation that the user 601 view a certain listing or region. Furthermore, the recommendation explainer 108 may perturb features (step 604) associated with data of the interaction graph 602, or a recommendation made in connection therewith, to identify relevant features. Example aspects of perturbing feature are described in connection with FIG. 4. The recommendation explainer 108 may use the identified relevant features 606 as part of perturbing a structure (step 608) of the interaction graph 602 and as part of an aggregation operation (step 612).

As further illustrated by the example of FIG. 6, the recommendation explainer 108 may perturb the structure (step 608) of the interaction graph, example aspects of which are described in connection with FIG. 5. The subgraph 610 illustrates data that may be generated by the recommendation explainer 108 while perturbing a structure of the graph 602. For example, the subgraph 610 may illustrate a 2-hop subgraph centered around the user 601. Using the subgraph 610, the recommendation explainer 108 may identify relevant edges 611, as described in connection with FIG. 5.

The recommendation explainer 108 may aggregate (step 612) the relevant features 606 and the relevant edges 611. For example, the recommendation explainer 108 may provide an application for displaying data associated with the relevant features and edges. As another example, the recommendation explainer 108 may generate one or more of a visualization or natural language text using one or more of the features 606 or the edges 611, as described in connection with the steps 222 and 224, respectively.

FIGS. 7-8 illustrate example visualizations 700 and 800 that may be generated by the recommendation explainer 108 using one or more of the identified relevant edges or features. The key 702 indicates the entities represented by the visualizations 700 and 800. Each of the visualizations includes a target user U, a recommended city R, cities as represented by dots, and explanations represented by bolded lines. The explanations shown by FIGS. 7 and 8 may correspond to the relevant edges identified by perturbing the graph. As shown, in the example of FIGS. 7-8, the recommended region is a recommended city. Graphs of the visualizations 700 and 800 may correspond to graphs generated by the recommendation explainer 108 following the step 510 of the method 500. For example, the visualizations 700 and 800 show edges between co-selected cities, and the graph is collapsed such that the user node U is directly connected to the city nodes, and listing nodes are not illustrated.

In the visualization 700, the user only has two relevant 1-hop edges. One of these however is connected to a city with many additional connections, including the recommended city. It may be inferred from this that regions that are very connected to other regions may act as a hub of information passing. Therefore, removing edges between the user and the heavily connected regions results in a loss of information; hence, they are identified as important in the visual explanation. The visualization 800 again shows the importance of highly connected regions. This time, the recommended city is 3-hops away from the user, going through two cities that are acting as information passing hubs.

FIG. 9 illustrates an example user interface 900. The user interface 900 may be part of an application 124 described in connection with FIG. 1. For example, a user may communicate with components of the information system 102 via the user interface 900. In the example shown, the user interface 900 enables a user to search for and view real estate. In the example shown, the user interface 900 includes a search field 902, search results 904, recommended regions 906, recommended listings 908, and an explanation 910.

The search field 902 may include one or more input fields via which a user may specify one or more attributes for a search. For example, the user may input one or more features of a listing that correspond to features described in connection with the listing data 116. The application server 104 may, based on the inputs received via the search field 902, return the search results 904.

The search results 904 include data corresponding to one or more listings that match the data input via the search field 902. In some embodiments, the search results 904 include, as shown, an interactive, dynamic map via which the user may select and view listings. Furthermore, the search results 904 may, as shown, include data corresponding to a selected listing. Additionally, the search results 904 may include one or more options for performing additional operations with respect to the listing, such as favoriting or saving the listing.

The components 906, 908, and 910 of the user interface 900 correspond to one or more recommendation to the user 128. For example, the recommended regions 906 and the recommended listings 908 may be generated by the recommendation system 106, and the explanation 910 may correspond to an explanation generated by the recommendation explainer 108. In some embodiments, the recommendations may be generated automatically in response to receiving one or more searches from the user 128, whereas in other embodiments, the user 128 may request, using a feature of the application 124, that the recommendations be generated.

The recommended regions 906 include one or more regions recommended to the user 128. The recommended listings 908 include one or more listings recommended to the user 128. In some instances, the listings of the recommended listings are located in a selected region of the recommended regions 906. In some embodiments, the recommendation system 106 determines the recommended regions or the recommended listings by using a trained heterogenous graph neural network to perform a link prediction task, in which an edge between a node representing the user 128 is predicted between nodes representing the recommended regions 906 or listings 908. Example aspects of generating such recommendations using the recommendation system 106 are described in connection with the steps 202-214 of FIG. 2. Additionally, as shown, the user interface 900 may include buttons that may be selected by the user 128 to view additional details regarding the recommended regions and recommended listings.

The explanation 910 includes an explanation generated by the recommendation explainer 108 for the recommendations displayed in one or more of the recommended regions 906 or recommended listings 908. As shown, the explanation 910 is natural language text. The explanation 910 may be based on features of the recommended region (e.g., the recommended region having listings with certain features that match the features input via the search field 902) that may be determined by the recommendation explainer 108 by perturbing features of the heterogenous graph, as described in connection with FIG. 4. Moreover, the explanation 910 may also be based on a topology of the heterogenous graph, as indicated by the explanation 910 including characteristics of other nodes and edges of the graph, such as actions associated with other user nodes, as described in connection with FIG. 5. As will be understood, the user interface 900 is an example of certain aspects of the present disclosure, and the user interface 900 could include more or fewer components than those illustrated in connection therewith.

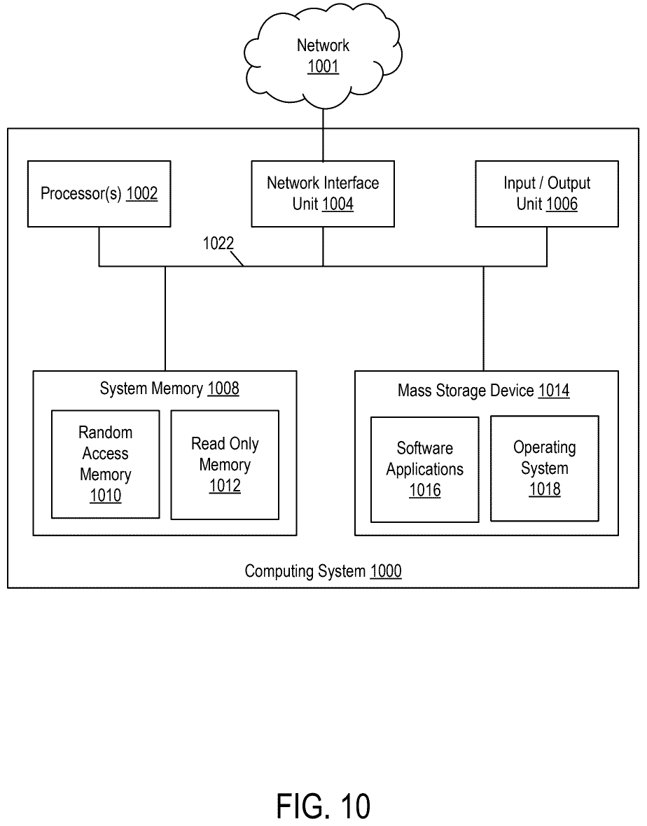

FIG. 10 illustrates an example block diagram of a virtual or physical computing system 1000. One or more aspects of the computing system 1000 can be used to implement the system and processes described herein. In the embodiment shown, the computing system 1000 includes one or more processors 1002, a system memory 1008, and a system bus 1022 that couples the system memory 1008 to the one or more processors 1002. The system memory 1008 includes RAM (Random Access Memory) 1010 and ROM (Read-Only Memory) 1012. A basic input/output system that contains the basic routines that help to transfer information between elements within the computing system 1000, such as during startup, is stored in the ROM 1012. The computing system 1000 further includes a mass storage device 1014. The mass storage device 1014 is able to store software instructions and data. The one or more processors 1002 can be one or more central processing units or other processors.

The mass storage device 1014 is connected to the one or more processors 1002 through a mass storage controller (not shown) connected to the system bus 1022. The mass storage device 1014 and its associated computer-readable data storage media provide non-volatile, non-transitory storage for the computing system 1000. Although the description of computer-readable data storage media contained herein refers to a mass storage device, such as a hard disk or solid-state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 1100.

According to various embodiments of the invention, the computing system 1000 may operate in a networked environment using logical connections to remote network devices through the network 1001. The network 1001 is a computer network, such as an enterprise intranet and/or the Internet. The network 1001 can include a LAN, a Wide Area Network (WAN), the internet, wireless transmission mediums, wired transmission mediums, other networks, and combinations thereof. The computing system 1000 may connect to the network 1001 through a network interface unit 1004 connected to the system bus 1022. It should be appreciated that the network interface unit 1004 may also be utilized to connect to other types of networks and remote computing systems. The computing system 1000 also includes an input/output controller 1006 for receiving and processing input from a number of other devices, including a touch user interface display screen, or another type of input device. Similarly, the input/output controller 1006 may provide output to a touch user interface display screen or other type of output device.

As mentioned briefly above, the mass storage device 1014 and the RAM 1010 of the computing system 1000 can store software instructions and data. The software instructions include an operating system 1018 suitable for controlling the operation of the computing system 1000. The mass storage device 1014 and/or the RAM 1010 also store software instructions, that when executed by the one or more processors 1002, cause one or more of the systems, devices, or components described herein to provide functionality described herein. For example, the mass storage device 1014 and/or the RAM 1010 can store software instructions that, when executed by the one or more processors 1002, cause the computing system 1000 to receive and execute managing network access control and build system processes.

Techniques of the recommendation explainer 108 have been empirically compared to prior techniques for explaining recommendations generated by graph neural networks. For example, the recommendation explainer 108 was compared against a graph neural network-based recommendation explainer (PaGE-Link) and two general graph neural explainers (GNN Explainer and SubgraphX). The results are shown below in Table 1.

TABLE 1
Quantitative Evaluation of Recommendation Explainer 108

| | Recommendation | PaGE- | | |
|---|---|---|---|---|
| Change in | Explainer 108 | Link | GNNExplainer | SubgraphX |
| nDCG (%) | −94 | −81 | −21 | −47 |
| Cosine | −0.10 | −0.07 | −0.02 | −0.04 |
| similarity | | | | |

Table 1 quantitatively evaluates the performance of the recommendation explainer 108 and illustrates that the recommendation explainer 108 is better able to identify node features and graph edges that have the most impact on generating the recommendations. Accordingly, modifying the features identified by the recommendation explainer 108 or removing the edges identified by the recommendation explainer 108 have a greater impact on model performance than the features and edges identified by the previous explainers.

For example, when compared to GNNExplainer, the recommendation explainer 108 demonstrates a −71% greater reduction in nDCG and −0.08 greater cosine similarity decrease, indicating that it more effectively identifies the features and subgraphs the GNN relies on to make recommendation. Similarly, against SubgraphX, the recommendation explainer 108 shows greater degradation in both metrics. Further, the recommendation explainer 108 has 13% more decrease in nDCG than PaGE-Link because the recommendation explainer 108 may, in some embodiments, consider the entire graph and all the available features as context, whereas PaGE-Link is limited by the ego-graph size and is unable to consider some of the relevant features that are important to the graph neural network. This limitation also impacts PaGE-Link in identifying relevant subgraph structures which is reflected by −0.03 less decrease is cosine similarity. These results highlight the recommendation explainer 108's distinct advantages over existing explainers in altering model behaviors and disrupting reliance on original explanations.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, two or more operations can be performed as a single operation, additional operations can be performed, and disclosed operations can be excluded without departing from the present disclosure. Further, certain operation can be accomplished via one or more sub-operations. The disclosed methods and processes, or aspects of the disclosed methods and processes, can be repeated. Moreover, although certain operations are described as being performed by certain components, other components may perform such operations, depending on the embodiment, as will be understood by those having ordinary skill in the art.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

What is claimed is:

1. A graph neural network system, the system comprising:
a heterogenous graph neural network trained to perform a link prediction task, the link prediction task comprising determining a likelihood of an edge between a first node of a first node type and a second node of a second node type;
a recommendation explainer configured to:
perturb features of the second node to identify relevant features of the second node for explaining the likelihood of the edge between the first node and the second node; and
using the relevant features of the second node, perturb a structure of the heterogenous graph neural network to identify relevant edges for explaining the likelihood of the edge between the first node and the second node.

2. The system of claim 1,
wherein the first node represents a user;
wherein the second node represents a geographical region;
wherein the graph neural network system is configured to generate a recommendation of the geographical region to the user based on the likelihood of the edge between the first node and the second node; and
wherein the recommendation explainer is further configured to explain the recommendation using data associated with one or more of the relevant features or the relevant edges.

3. The system of claim 1,
wherein the first node type represents users;
wherein the second node type represents geographical regions;
wherein the heterogenous graph neural network further comprises:
a third node type representing listings; and
heterogenous edge types, wherein the heterogenous edge types comprise view edges between the users and the listings, and contain edges between the geographical regions and the listings.

4. The system of claim 1,
wherein perturbing the features of the second node comprises:
modifying a feature value for a feature of a plurality of features of the second node;
reevaluating the heterogenous graph neural network to determine a performance degradation associated with the modified feature value; and
in response to determining that the performance degradation is greater than a threshold, including the feature in the relevant features.

5. The system of claim 4, wherein perturbing the features of the second node further comprises:
identifying a plurality of similar nodes of the second node type that are similar to the second node;
determining an average feature vector of the plurality of similar nodes; and
determining a difference between the average feature vector of the plurality of similar nodes and a feature vector for the second node.

6. The system of claim 1, wherein perturbing the structure of the heterogenous graph neural network comprises:
determining a similarity between first embeddings of the first node and second embeddings of the second node;
adding, to the heterogenous graph neural network, a co-selected edge between a pair of nodes of the second node type in response to determining that each node of the pair of nodes of the second node type has an edge to a common node of the first node type; and
for each edge of a plurality of edges of the heterogenous graph neural network:
remove the edge;
regenerate the first embeddings of the first node and the second embeddings of the second node using the heterogenous graph neural network without the edge;
determine an updated similarity between the regenerated first embeddings of the first node and the regenerated second embeddings of the second node;
determine a difference between the similarity and the updated similarity; and
in response to determining that the difference is greater than a threshold, including the edge in the relevant edges.

7. The system of claim 6, wherein the pair of nodes of the second node type are co-selected geographical regions.

8. The system of claim 6, wherein perturbing the structure of the heterogenous graph neural network comprises, prior to adding the co-selected edge to the heterogenous graph neural network:
removing intermediate nodes between nodes of the first node type and nodes of the second node type; and
creating a k-hop subgraph centered on the first node.

9. The system of claim 6, wherein perturbing the structure of the heterogenous graph neural network comprises evaluating an interaction graph using only the relevant features for the second node.

10. The system of claim 1,
further comprising a machine learning platform configured to train the heterogenous graph neural network;
wherein training the heterogenous graph neural network comprises:
accessing historical session data comprising a plurality of users and a plurality of actions between the plurality of users and a plurality of listings;
accessing geographical data, the geographical data comprising a plurality of geographical regions containing the plurality of listings;
inferring edges between the plurality of users and the plurality of geographical regions by using the historical session data and the geographical data; and
performing supervised learning to train the heterogenous graph neural network using the historical session data.

11. The system of claim 1,
wherein the heterogenous graph neural network comprises:
a node embedding layer trained to map feature vectors of nodes of the first node type to a shared embedding space and trained to map feature vectors of nodes of the second node type to the shared embedding space;
a message passing layer configured to update embeddings for a node using previous embeddings for the node and edge type-specific transformations of embeddings of neighboring nodes to the node; and
a link prediction layer trained to determine similarities between nodes of the first node type and nodes of the second node type.

12. A method for explaining a heterogenous graph neural network, the method comprising:
receiving a heterogeneous interaction graph comprising a first node of a first node type and a second node of a second node type;
receiving data corresponding to a recommendation between the first node and the second node, wherein the recommendation is based on the heterogenous graph neural network processing the interaction graph;
perturbing features of the second node to identify relevant features of the second node for explaining the recommendation between the first node and the second node; and
perturbing a structure of the heterogenous interaction graph to identify relevant edges for explaining the recommendation between the first node and the second node.

13. The method of claim 12, further comprising generating a visualization of an explanation for the recommendation, wherein the visualization comprises the first node, the second node, and the relevant edges, wherein the relevant edges are highlighted or bolded in the visualization.

14. The method of claim 12, further comprising generating a natural language explanation for the recommendation by using a large language model to generate text using the relevant features and the relevant edges.

15. The method of claim 12, wherein the first node represents a user and the second node represents a city.

16. The method of claim 12,
wherein the second node is a geographical region; and
wherein the relevant features are selected from a set of features comprising numerical data associated with one or more of a bedroom count, a bathroom count, a year built, or a square footage of listings in the geographical region.

17. The method of claim 12, further comprising, displaying, via a user interface of a web application or a mobile application, the recommendation and an explanation for the recommendation generated using the relevant features or the relevant edges.

18. A recommendation explainer computing system, the recommendation explainer computing system comprising:
a processor; and
memory storing instructions that, when executed by the processor, cause the recommendation explainer computing system to:
receive data associated with a heterogeneous interaction graph comprising a first node of a first node type and a second node of a second node type;
receive a recommendation generated by a heterogenous graph neural network that recommends a region associated with the second node to a user associated with the first node;
perturb features of the second node to identify relevant features of the second node for explaining the recommendation;
using the relevant features of the second node, perturb a structure of the heterogenous interaction graph to identify relevant edges; and
generate the explanation using the relevant features and the relevant edges.

19. The recommendation explainer computing system of claim 18,
wherein perturbing the features of the second node comprises:
modifying a feature value for a feature of a plurality of features of the second node;
reevaluating the heterogenous graph neural network to determine a performance degradation associated with the modified feature value; and
in response to determining that the performance degradation is greater than a threshold, including the feature in the relevant features; and
wherein perturbing the structure of the heterogenous interaction graph comprises:
determining a similarity between first embeddings of the first node and second embeddings of the second node;
adding, to the heterogenous interaction graph, edges between pairs of nodes of the second node type in responses to determining that the pairs of nodes of the second node type have an edge to a common node of the first node type; and
for each edge of a plurality of edges of the heterogenous interaction graph:
remove the edge;
regenerate the first embeddings of the first node and the second embeddings of the second node using the heterogenous interaction graph without the edge;
determine an updated similarity between the regenerated first embeddings of the first node and the regenerated second embeddings of the second node;
determine a difference between the similarity and the updated similarity; and
in response to determining that the difference is greater than a threshold, including the edge in the relevant edges.

20. The recommendation explainer computing system of claim 18, wherein the heterogenous interaction graph comprises a third node type between first node type and the second node type.
